(19) United States
(12) Patent Application Publication
(10) Pub. No.: US 2017/0361692 A1
(43) Pub. Date: Dec. 21, 2017

(54) LATCH SYSTEM FOR PICKUP BED TONNEAU COVER

(71) Applicant: American Specialty Cars, Warren, MI (US)

(72) Inventors: George Albert Corder, (US); Paul Finch, Northville, MI (US); Joseph Orlando, (US); Steven Laurain, (US); David Brooks, (US)

(73) Assignee: American Specialty Cars, Warren, MI (US)

(21) Appl. No.: 15/625,320

(22) Filed: Jun. 16, 2017

Related U.S. Application Data
(60) Provisional application No. 62/351,089, filed on Jun. 16, 2016.

(51) Int. Cl. B60J 7/19; E05C 3/16; B60J 7/16

(52) U.S. Cl. CPC B60J 7/198; E05C 3/16; B60J 7/1607

(57) ABSTRACT

A latch assembly for clamping a pickup truck cover to a truck bed is disclosed. The assembly includes a base mount fixed to the cover side rail, a cam assembly having first and second cam surfaces, and a handle assembly rotatably attached to the mount. The handle assembly is movable between stowed and clamping positions and includes a lever rotatably mounted to the mount, a grip slidably mounted on the lever, and a pivotable locking arm associated with the cam surfaces. The arm includes a grip for clamping against the bed. The first cam surface has a stowing cam profile for moving the arm to its stowed position. The second cam surface has a locking cam profile for moving the arm to its clamping position. The arm includes a follower for engagement with the cam surfaces. The base mount includes a grip-engaging feature. The grip includes a base mount-engaging feature.

### CROSS REFERENCE TO RELATED APPLICATION

This application claims the benefit of U.S. provisional patent application Ser. No. 62/351,089 filed Jun. 16, 2016, entitled LATCH SYSTEM FOR PICKUP BED TONNEAU COVER, which is hereby incorporated by reference.

### TECHNICAL FIELD

The disclosed inventive concept relates to bed tonneau covers for pickup trucks. More particularly, the disclosed inventive concept relates to latches for securing the pickup bed tonneau cover to the top rail of the pickup bed. Still more particularly, the disclosed inventive concept relates to a latch for securing the pickup bed tonneau cover to the top rail of the pickup bed by way of relatively easy movements of the latch between its latched, unlatched and stowed positions.

### BACKGROUND OF THE INVENTION

The use of covers on pickup truck beds typically incorporates one of three types of covers. The simplest of these designs is the entirely flexible, non-reinforced roll-up cover formed from a cloth or a polymerized material. While being easy to install and remove and being of low cost, the roll-up covers cannot support weights of, for example, snow. Other covers include solid, one-piece covers and multi-segmented covers having individual frame segments that are covered by cloth or a polymerized material.

Regardless of design, tonneau covers are designed so as to be removable as may be necessary to accommodate loads that exceed the height of the bed with the tonneau cover in place. In the case of solid or segmented tonneau covers, ease of removability of the tonneau cover varies widely, though, as a general rule, the amount of latching hardware involved in securing tonneau covers to truck beds is often excessive and typically requires both a great amount of time and effort to attach, release and stow. The difficulty generally lies in the fact that designers focus on the importance of keeping the cover securely latched to the pickup bed for safety rather than on ease of movement.

The solid, one-piece cover is typically hinged at its vehicle-forward end to the top rail of the truck bed and is selectively latched to the truck bed at its opposite end. Conversely, the flexible, non-reinforced cover is often snapped to the top rail of the truck bed to maintain its covered position. The multi-segmented tonneau cover typically includes at least four latches, two along each side rail, that provide positive attachment of the cover to the pickup bed. Some latching solutions rely on C-clamps that attach the tonneau cover to the upper rails of the bed. While providing a good degree of security, C-clamps are often difficult to correctly position and properly install, particularly because of the great variety of designs of rails between vehicle brands and types. The use of C-clamps may also result in unsatisfactory installation because of the difficulty of correct installation.

In response to the challenge of using C-clamps to attach the tonneau cover to the pickup bed rail, designers developed a variety of latches that are usually, but not always, attached to a rigid part of the tonneau cover itself. These latches are of a variety of types and include, for example, hinged latches that require the operator to use both hands when locking the latch into place. The “two-handed” operation involves the use of one hand to hold the latching part in position against the rail of the pickup bed and the other to move the handle of the latch to its locked position.

In addition, the typical tonneau cover latch, which is usually attached to the underside of the tonneau cover, is incapable of being stowed when not in use, thus resulting in a latch that dangles inconveniently from the underside of the tonneau cover when not in its latching position. While often providing satisfactory results in maintaining a secure relationship between the tonneau cover and the pickup bed, known latching systems are cumbersome and are difficult to operate.

In an effort to provide a stowable latch, present efforts include a latch that can be moved from its latching position to a pre-stowed position, then twisted (or rotated) to a stowed position. This approach provides a stowed latch that is moved out of the way, but necessitates extra movements on the part of the operator which prove inconvenient.

As in so many areas of vehicle technology there is always room for improvements related to the latching of tonneau covers to pickup beds. Particularly, it would be advantageous to provide an effective tonneau cover latch that can be easily set to its latching position and stowed under the tonneau cover and thus out of the way when not in use.

### SUMMARY OF THE INVENTION

The disclosed inventive concept overcomes the problems of known latches for tonneau covers by providing a latch assembly that is relatively easy to move between its stowed position and its clamping position. The latch assembly of the disclosed inventive concept uses the fewest number of parts. Importantly, the latch assembly of the disclosed inventive concept allows for an operator to move the latch between its stowed and clamping positions with the least amount of effort using only one hand.

Particularly, the latch assembly of the disclosed inventive concept is used for engaging and disengaging a pickup truck bed cover, such as a tonneau cover having a side rail, relative to a pickup truck bed having an upper rail. The latch assembly includes a base mount fixed to the side rail of the cover, a cam assembly having a first cam surface and a second cam surface, and a handle assembly that is rotatably attached to the base mount. The handle assembly is movable between a stowed position and a clamping position. Unlike the prior art, the latch can be moved from its latched position to its stowed position along the same axis without the need to twist the latch to its stowed position.

The handle assembly includes a lever rotatably mounted to the base mount, a slidable grip slidably mounted on the lever, and a pivotable locking arm operatively and selectively associated with the first and second cam surfaces. The pivotable locking arm includes a grip for clamping against the upper rail of the bed when the handle assembly is in its clamping position.

The first cam surface and said second cam surface are joined and are continuous with one another. The first cam surface has a concave stowing cam profile for moving the pivotable locking arm to its stowed position and the second cam surface has a concave locking cam profile for moving the pivotable locking arm to its clamping position. The pivotable locking arm includes a follower end having a follower for selective engagement with the first and second cam surfaces.

A biasing element such as a spring is provided between the slidable grip and the base mount for urging the slidable grip toward the base mount. The base mount includes a slidable grip-engaging feature and the slidable grip includes a base mount-engaging feature.

The above advantages and other advantages and features will be readily apparent from the following detailed description of the preferred embodiments when taken in connection with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention wherein:

FIG. 1 is a partially sectional side view of the attachment assembly according to the disclosed inventive concept shown in its stowed position;

FIG. 2 is a bottom view of the attachment assembly illustrated in FIG. 1 in its stowed position;

FIG. 3 is a partially sectional side view of the attachment assembly shown after having been released from being stowed;

FIG. 4 is a partially sectional side view of the attachment assembly initially moved toward its clamping position;

FIG. 5 is a perspective view of the attachment assembly in generally the position shown in FIG. 4;

FIG. 6 is a partially sectional side view of the attachment assembly moved further toward its clamping position in which the cam follower is following the locking cam profile;

FIG. 7 is a partially sectional side view of the attachment assembly illustrated in its clamping position;

FIG. 8 is a perspective view of the attachment assembly in its clamping position;

FIG. 9 is similar to FIG. 7 but illustrating the slidable grip having been moved to its release position in anticipation of releasing the attachment assembly from its clamping position;

FIG. 10 is similar to FIG. 9 but illustrating the lever having been released from its locked position relative to the base mount;

FIG. 11 is a partially sectional side view of the attachment assembly being moved to its fully stowed position in which the cam follower is following the stowing cam profile of the cam assembly; and

FIG. 12 is a sectional view illustrating ridges formed to each side of the truck bed-engaging grip of the pivotable locking arm.

### DETAILED DESCRIPTION OF THE PREFERRED EMBODIMENT

In the following figures, the same reference numerals will be used to refer to the same components. In the following description, various operating parameters and components are described for different constructed embodiments. These specific parameters and components are included as examples and are not meant to be limiting.

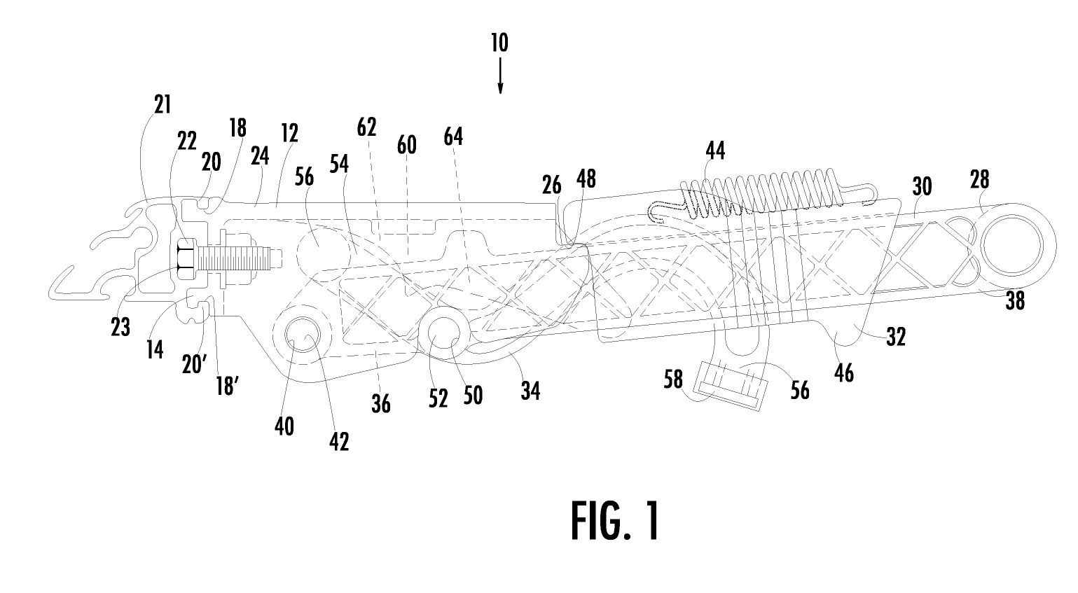

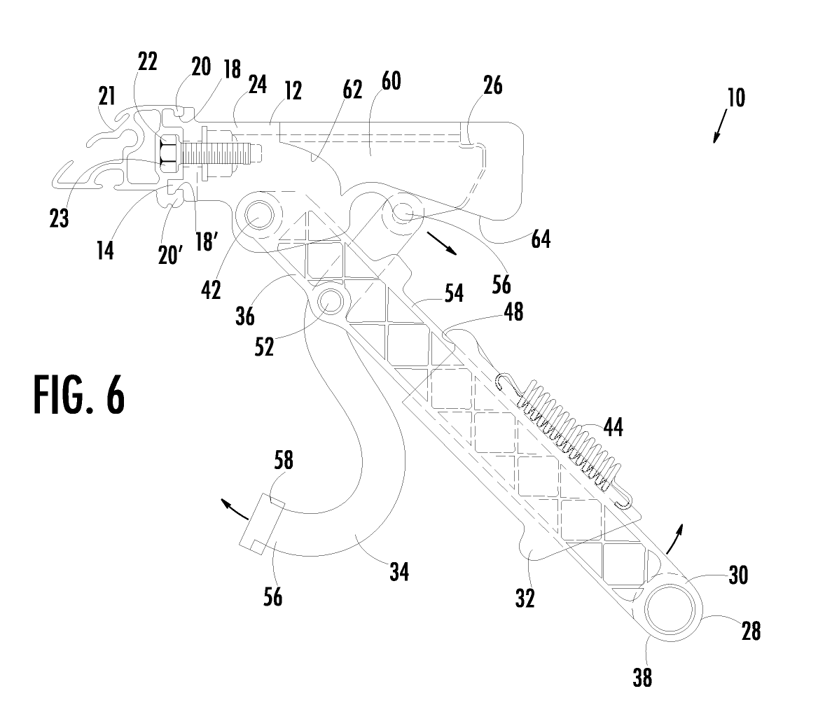

The preferred embodiment of a latch assembly for use in locking a pickup truck tonneau to a pickup truck bed cover is shown in FIGS. 1-11. It is to be understood that when reference is made to “pickup truck bed” that this reference is to a structure for a pickup truck that includes a generally horizontal base wall, vertical side, front and back walls and a pivoting gate that is selectively lowered and raised to as desired to open or close the area of the bed. It is also to be understood that the tonneau cover to which the latch assembly of the disclosed inventive concept is attached may be of any of a variety of types of covers as the disclosed latch assembly is suitable for use on virtually any tonneau cover or similar cover.

The latch assembly of the disclosed inventive concept finds particular application on a multi-segmented tonneau cover of the type that includes individual segments that are rotatably attached. Each segment includes a front cross rail and a rear cross rail, both the front and rear cross rails extending in a cross-car direction. The front cross rail and the rear cross rail are each connected by a pair of opposed side rails. As is understood, the latch assembly of the disclosed inventive concept attaches to a side rail as will be described below.

The figures illustrate the latch assembly of the disclosed inventive concept in several stages of operation between being stowed during non-use to its clamping position in which the tonneau cover is held to the upper rail of the pickup truck bed. It is to be understood that the configuration of the latch assembly of the disclosed inventive concept is preferred but not necessarily exclusive, as other configurations could be adopted without deviating from the spirit or scope of the present invention as described and claimed.

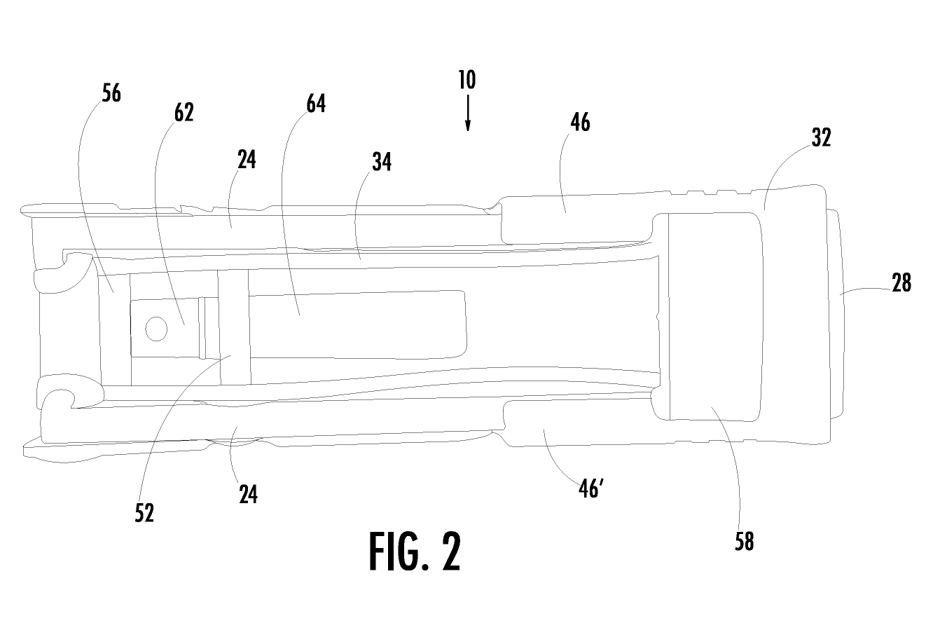

Referring to FIGS. 1 and 2, a latch assembly, generally illustrated as 10, is shown in its generally horizontal stowed position in which the latch assembly 10 is out of the way of the operators when the tonneau cover segments are being folded and unfolded. The latch assembly 10 includes a base mount 12 having a rail attachment end 14. The rail attachment end 14 includes two opposed channels 18 and 18′ into which are slotted two flanges 20 and 20′ respectively that are formed on a side rail 21. As is understood by one skilled in the art, on assembly of the relevant segment of the tonneau cover, the two opposed channels 18 and 18′ are fitted between the two flanges 20 and 20′, thereby allowing the base mount 12 to be slid onto the open end of the side rail 21 before attachment thereto of an end rail. The base mount 12 may be fixedly attached to the side rail 21 by, for example, mechanical fastening using a nut and bolt assembly 22 in which the head of the bolt is captured in a T-shaped channel 23 formed in the side rail 21. Other methods of mechanical fastening may be used. The nut and bolt assembly 22 secures the side rail 21 to the base mount 12.

The base mount 12 includes a pair of spaced apart and opposed walls 24 and 24′. Each of the walls 24 and 24′ includes a grip clamping flange of which one, a grip locking flange 26, is shown in FIG. 1 formed on the wall 24. It is to be understood that the opposed wall 24′ includes a grip clamping flange.

Rotatably attached to the base mount 12 is a handle or lever assembly 28. The handle assembly 28 includes a handle or lever 30, a slidable grip 32 slidably mounted on the handle 30, and a pivotable locking arm 34.

The lever 30 includes a first end 36 and a second end 38. The first end 36 of the lever 30 includes an attachment pin aperture 40 into which a pivot pin 42 is inserted.

The slidable grip 32 includes a return spring 44 that urges the slidable grip 32 toward the first end of the 36 of the handle 30. The slidable grip 32 further includes two side walls 46 and 46′. Each of the grip side walls 46 and 46′ includes a base mount engagement flange of which one, a base mount engagement flange 48, is shown in FIG. 1. As illustrated in FIG. 1, when the handle assembly 28 is in its stowed position, the slidable grip 32 is urged to its base mount locking position by the return spring 44 such that the base mount engagement flanges of the slidable grip 32 enter into locked engagement with the grip engagement flanges of the base mount 12.

Rotatably attached to the handle assembly 28 is a pivotable locking arm 34. The pivotable locking arm 34 includes a locking arm pin aperture 50 into which is fitted a locking arm attachment pin 52. The locking arm attachment pin 52 rotatably attaches the pivotable locking arm 34 to the handle 30. The pivotable locking arm 34 includes a follower end 54 to which is rotatingly attached a follower or roller 56. The pivotable locking arm 34 also includes a grip end 56 that having a truck bed-engaging grip 58. The grip 58 may be formed from a rubber material or another polymerized material so that the selected material provides a relatively high coefficient of friction, thereby reducing or eliminating the possibility of the grip 58 becoming loose from the engaged surface on the truck bed wall. The polymerized surface also reduces the likelihood that the surface of the truck bed will become marred upon clamping of the latching assembly 10.

The cam follower 56 selectively engages a cam assembly 60 that is attached to or is part of the base mount 12. The cam assembly 60 has two profiles formed thereon. The first of these profiles is a stowing cam profile 62. The second of these profiles is a locking cam profile 64. During the stowing operation of the handle assembly 28, the cam follower 56 follows the stowing cam profile 62 as will be discussed below. As will also be discussed below, during the clamping operation of the handle assembly 28, the cam follower 56 follows the locking cam profile 64.

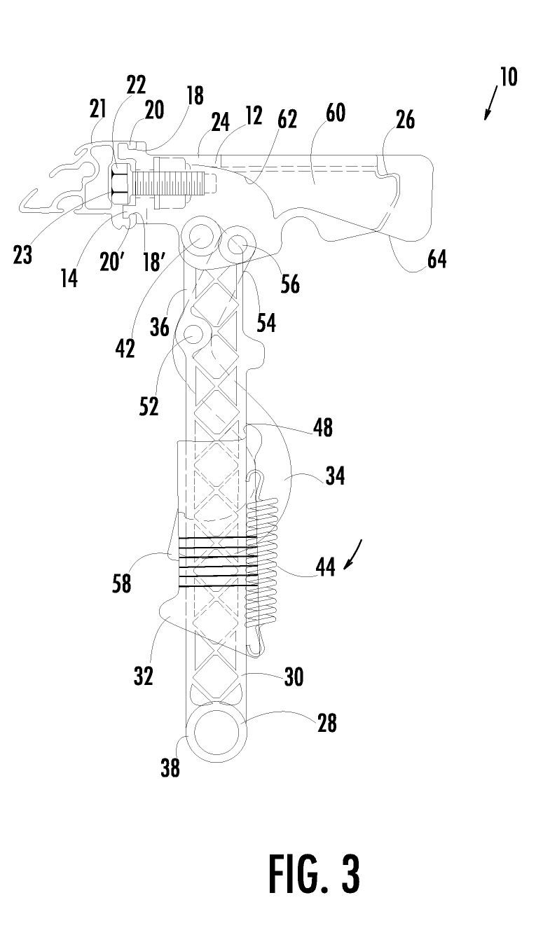

As noted, FIGS. 1 and 2 illustrate the latch assembly 10 in its generally horizontal stowed position. In this position, the latch assembly 10 is positioned out of the way, thereby allowing the tonneau cover segments to be folded and unfolded. Once the associated segment of the tonneau cover is fitted in place on the top of the pickup truck bed, the latch can be moved to its tonneau cover locking position relative to the pickup truck bed attachment point and, more particularly, relative to a top rail 66 of a pickup truck bed. As the first step toward moving the latch assembly 10 to its locking position, the operator grasps the slidable grip 32 and moves it against the biasing force of the return spring 44 and toward the second end 38 of the lever 30, thereby disengaging the base mount engagement flanges 48 and 48′ from the grip locking flanges 26 and 26′ respectively. Thus disengaged, the handle assembly 28 is allowed to pivot downward to a substantially vertical position as illustrated in FIG. 3. The handle assembly 28 is now approximately half of the way between its stowed position and its engaged position.

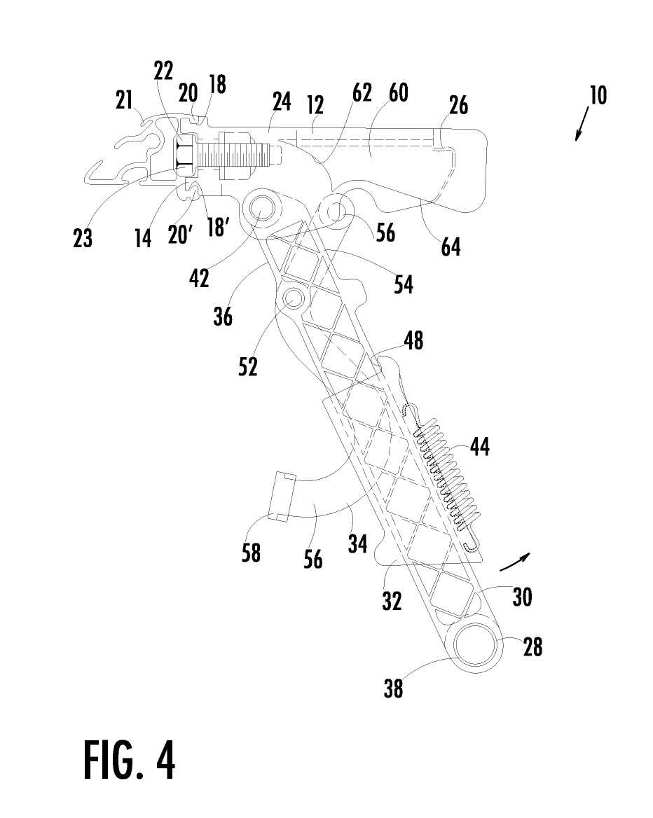

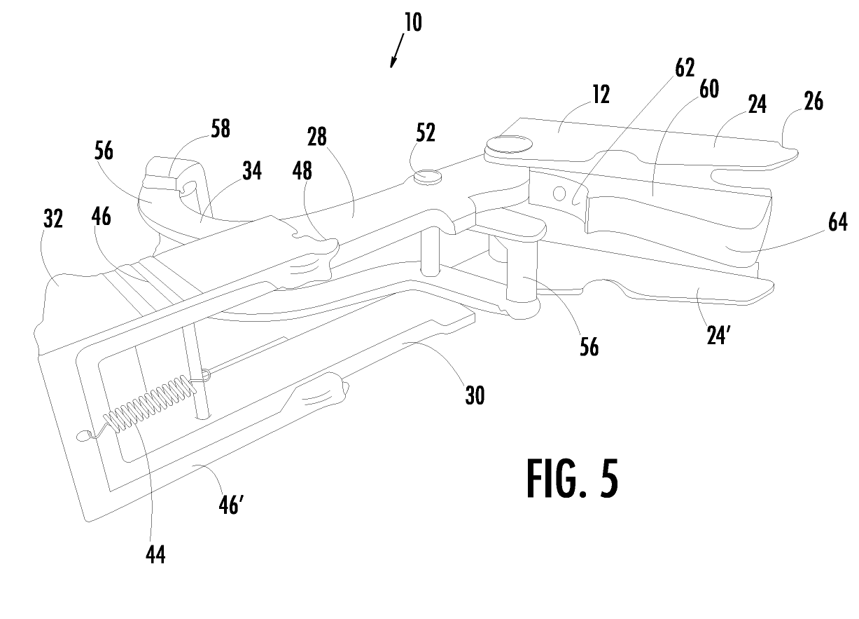

The next step toward clamping is illustrated in FIG. 4 in which the handle assembly 28 is shown initially moved toward its clamping position. A perspective view of the handle assembly 28 in this position is generally illustrated in FIG. 5.

As shown in FIGS. 4 and 5, the handle assembly 28 is shown after being moved by the operator back partially toward its stowed position. However, the pivotable locking arm 34, allowed to pivot freely relative to the lever 30 by the locking arm attachment pin 50, moves essentially independent of the lever 30. Responding to gravity, the heavier grip end 56 of the pivotable locking arm 34 tends to stay in its down position as illustrated in FIG. 4 while the lever 30 is moved back to its stowed position as indicated by the arrow. As shown in FIG. 4, movement of the lever 30 in this direction causes engagement of the cam follower 56 at the follower end 54 of the pivotable locking arm 34 to engage the locking cam profile 64 of the cam assembly 60.

As illustrated by arrows, continuing movement of the lever 30 toward its stowed position in FIG. 5 results in the cam follower 56 continuing to follow the locking cam profile 64 of the cam assembly 60. This movement causes the grip end 56 of the pivotable locking arm 34 to be moved in the direction opposite that of the lever 30, or toward clamping with the top rail 66 of a pickup truck bed.

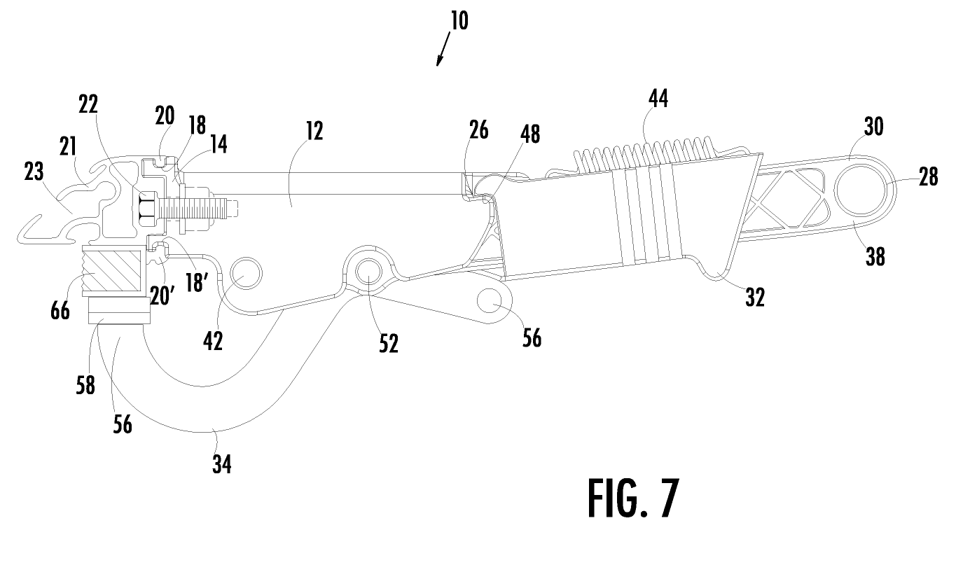

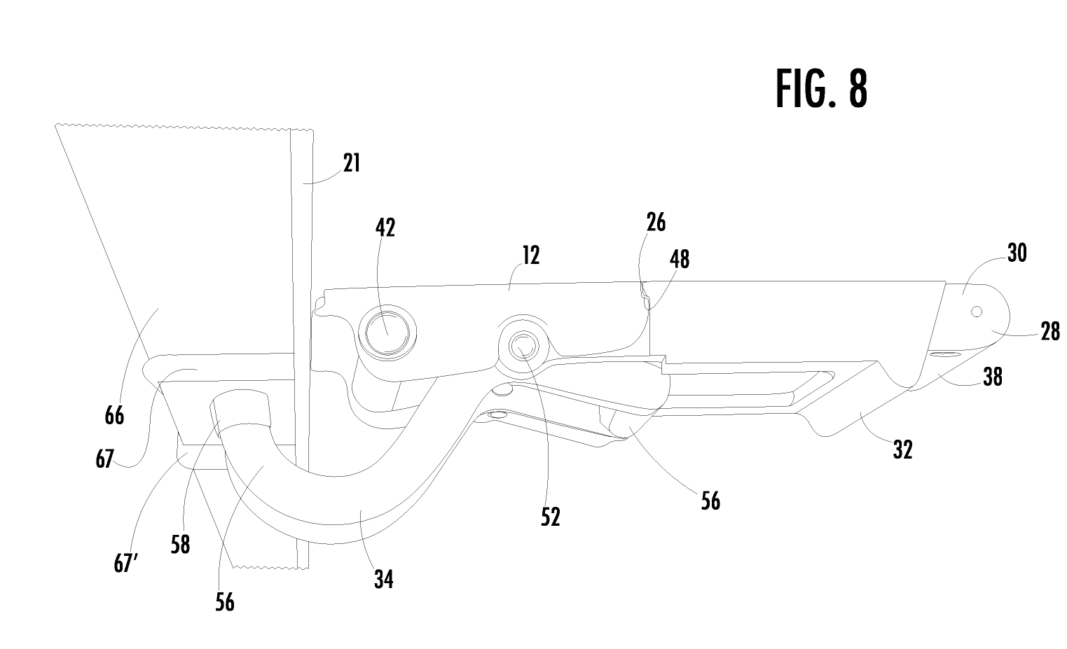

The operator continues moving the lever 30 toward the stowed position until the slidable grip 32 reengages the base mount 12 by reengagement of the grip locking flanges 26 and 26′ with the base mount engagement flanges 48 and 48′ from the respectively as illustrated in FIGS. 7 and 8. The biasing force of the return spring 44 retains the slidable grip 32 in its locked position against the base mount 12 until such time as the operator chooses to again release the lever 30 by movement of the slidable grip 32 toward the second end 38 of the lever 30.

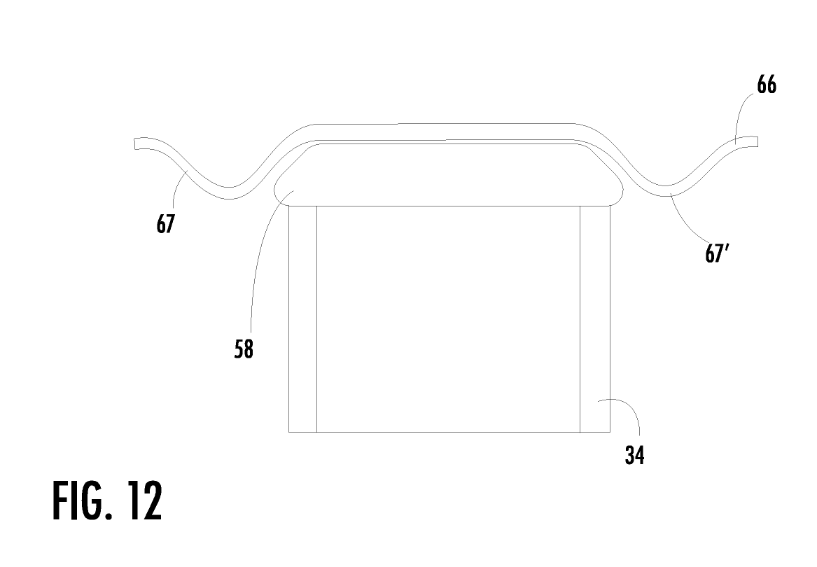

Simultaneous with the movement of the lever 30 toward its stowed position, the pivotable locking arm 34 moves toward its clamping position with respect to the top rail 66 of the pickup bed. Particularly, as the lever 30 is moved toward its stowed position, the cam follower 56 continues to follow the locking cam profile 64 of the cam assembly 60 until the pivotable locking arm 34 is moved to its fully engaged position in which the grip end 56 is pressed against the top rail 66 of a pickup truck bed. The tonneau cover is now fully clamped and is securely locked against the pickup truck bed as illustrated in FIG. 8. To prevent movement of the truck bed-engaging grip 58 of the pivotable locking arm 34 along the top rail 66, a pair of spaced apart travel-restricting ramps 67 and 67′ are formed on the underside of the top rail 66. This arrangement is also shown in FIG. 12.

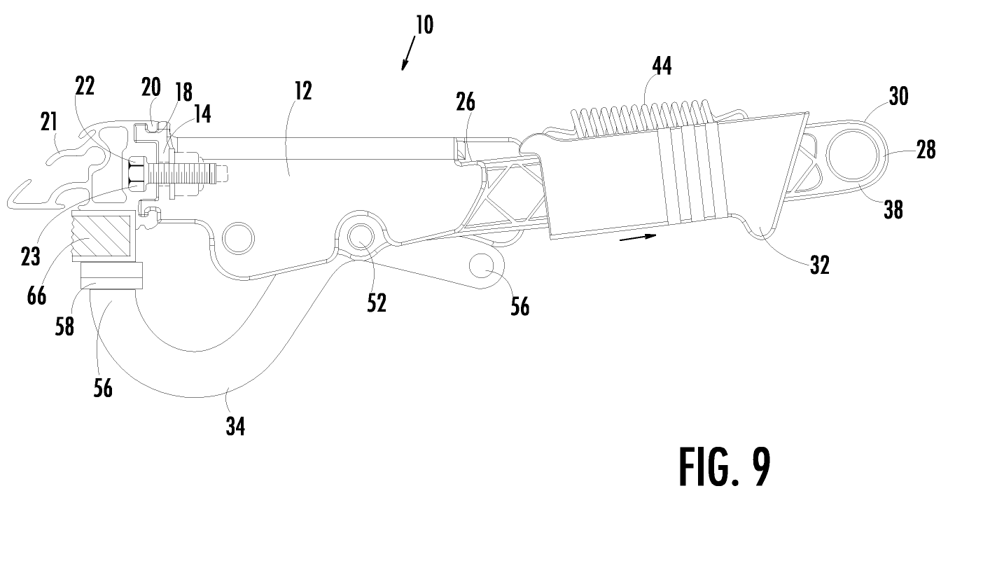

Should the operator decide to remove all or some of the tonneau cover from the pickup truck bed, the handle assembly 28 must first be released from its locking position. Release of the handle assembly 28 from its locked position is undertaken in reverse of the installation steps to be followed by stowage. Particularly, and referring to FIG. 9, the operator grasps the slidable grip 32 and moves it against the biasing force of the return spring 44 and toward the second end 38 of the lever 30, thereby disengaging the base mount engagement flanges 48 and 48′ from the grip locking flanges 26 and 26′ respectively.

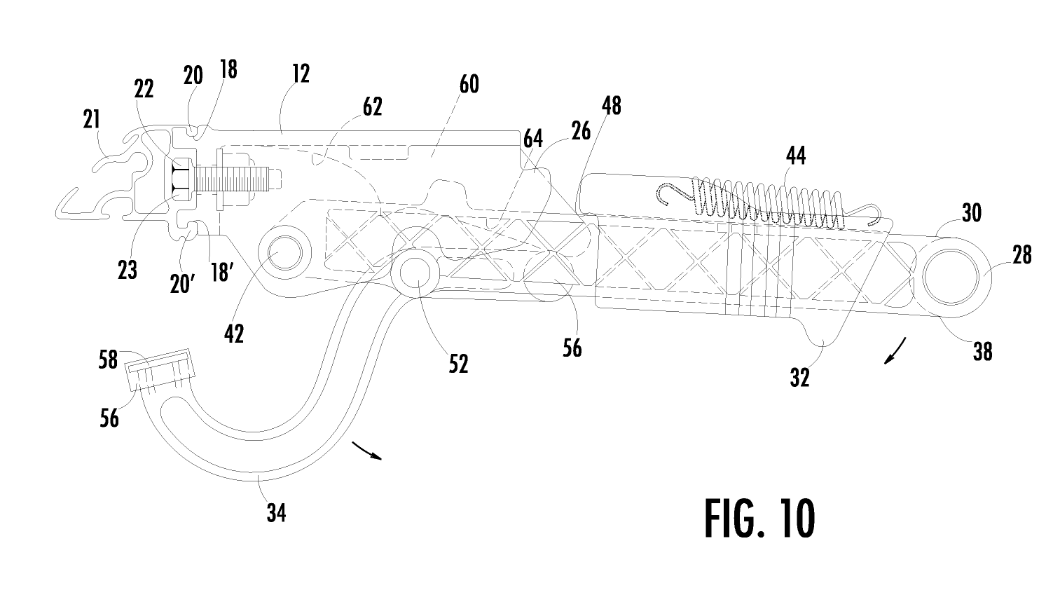

Thereafter, as illustrated in FIG. 10, the operator moves the lever 30 again toward its unlatched position shown in FIG. 3. While moving the lever 30, the grip 58 of the pivotable locking arm 34 falls away from the top rail 66 because of gravity, thus causing the locking arm 34 to initially pivot back to its stowed position due to rotation of the pivotable locking arm 34 relative to the lever 30.

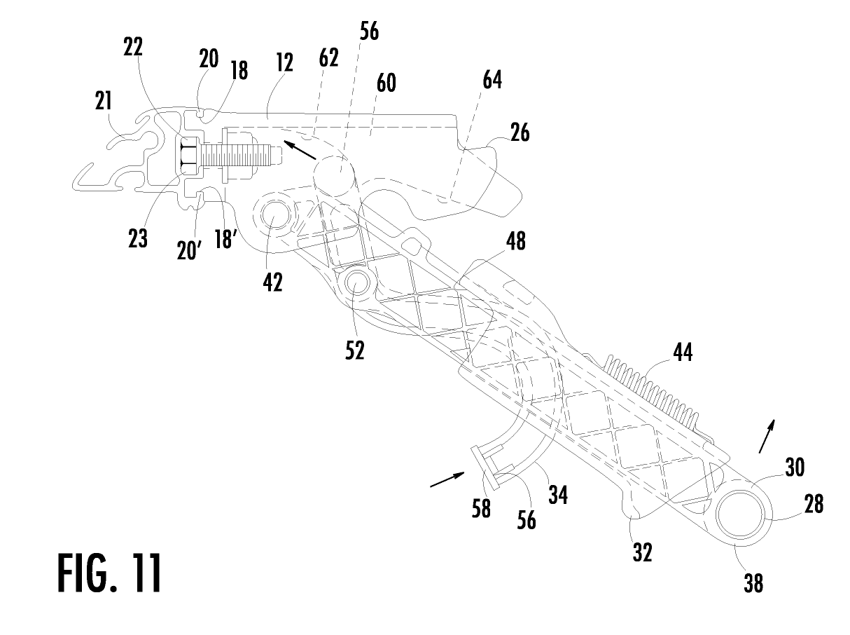

To return the handle assembly 28 to its fully stowed position, the operator continues to move the lever 30 upward toward its stowed position as illustrated in FIG. 11. The operator assists in the movement of the pivotable locking arm 34 by pressing on the grip 58 until the cam follower 56 engages the stowing cam profile 62. Simultaneous with movement of the lever 30 in this direction, the cam follower 56 engages the stowing cam profile 62 of the cam assembly 60 and continues to follow the stowing cam profile 62 while the lever 30 is moved into its locked position relative to the base mount 12. Thus the handle assembly 28 is returned to its fully stowed position as shown in FIGS. 1 and 2 and as discussed in relation thereto.

With respect to FIG. 12, a sectional view of the top rail 66 taken along its long axis in which the travel-restricting ramps 67 and 67′ are illustrated. Configured in this manner, the travel-restricting ramps 67 and 67′ provide a barrier against which the truck bed-engaging grip 58 of the pivotable locking arm 34 cannot pass, thus restricting movement of the grip 58 along the length of the top rail 66. It is to be understood that while two travel-restricting ramps 67 and 67′ are illustrated, it may be that only one of these features is necessary.

It is to be understood that while a single attachment assembly 10 is illustrated, the attachment assemblies are ordinarily provided in mirror pairs such that another latch assembly would be provided on the opposite side of the tonneau cover segment.

The latching arrangement of the disclosed inventive concept allows the operator to quickly and easily move the latch from its fully stowed position to its clamping position and back again seamlessly and using only a single hand. The latching arrangement of the disclosed inventive concept requires the least number of moving parts, is highly adaptable to a variety of tonneau covers, and provides a secure and effective attachment of the tonneau cover relative to the pickup truck bed.

One skilled in the art will readily recognize from the above discussion, and from the accompanying drawings and claims, that various changes, modifications and variations can be made therein without departing from the true spirit and fair scope of the invention as defined by the following claims.

What is claimed is:

1. A latch assembly for use with a cover for a pickup truck bed, the cover having a side rail and the bed having an upper rail, the assembly comprising:
a base mount fixed to the side rail of the cover;
a cam assembly having a first cam surface and a second cam surface;
a handle assembly rotatably attached to said base mount and movable between a stowed position and a clamping position, said handle assembly comprising a lever rotatably mounted to said base mount, a slidable grip slidably mounted on said lever, and a pivotable locking arm operatively and selectively associated with said first and second cam surfaces, said pivotable locking arm including a grip for clamping against the upper rail of the bed when the handle assembly is in said clamping position.

2. The latch assembly for use with a cover for a pickup truck bed of claim 1, wherein said first cam surface and said second cam surface are joined and are continuous with one another.

3. The latch assembly for use with a cover for a pickup truck bed of claim 1, wherein said first cam surface has a concave stowing cam profile for moving said pivotable locking arm to its stowed position.

4. The latch assembly for use with a cover for a pickup truck bed of claim 1, wherein said second cam surface has a concave locking cam profile for moving said pivotable locking arm to its clamping position.

5. The latch assembly for use with a cover for a pickup truck bed of claim 1, wherein said pivotable locking arm includes a follower end having a follower for engagement with said first and second cam surfaces.

6. The latch assembly for use with a cover for a pickup truck bed of claim 1, further including a biasing element for urging said slidable grip toward said base mount.

7. The latch assembly for use with a cover for a pickup truck bed of claim 1, wherein said base mount includes a slidable grip-engaging feature and said slidable grip includes a base mount-engaging feature.

8. A latch assembly for use with a cover for a pickup truck bed, the assembly comprising:
a base mount, said base mount including a first cam surface and a second cam surface;
a handle assembly rotatably attached to said base mount such that said handle rotates about a substantially horizontal axis and is movable between a stowed position, an unlatched position, and a clamping position, wherein said handle is substantially horizontal when in said stowed and clamping positions and is substantially vertical when in said unlatched position, said handle assembly including a pivotable locking arm operatively associated with said first and second cam surfaces, said pivotable locking arm being associated with said first cam surface when said handle assembly is in its stowed position and being associated with said second cam surface when said handle assembly is in its clamping position.

9. The latch assembly for use with a cover for a pickup truck bed of claim 8, wherein said handle assembly further includes a lever rotatably mounted to said base mount and a slidable grip slidably mounted on said lever.

10. The latch assembly for use with a cover for a pickup truck bed of claim 9, wherein said pivotable locking arm including a grip for clamping against the pickup truck bed when the handle assembly is in said clamping position.

11. The latch assembly for use with a cover for a pickup truck bed of claim 8, wherein said first cam surface and said second cam surface are joined and are continuous with one another and wherein said first cam surface has a concave stowing cam profile for moving said pivotable locking arm to its stowed position.

12. The latch assembly for use with a cover for a pickup truck bed of claim 11, wherein said second cam surface has a concave locking cam profile for moving said pivotable locking arm to its clamping position.

13. The latch assembly for use with a cover for a pickup truck bed of claim 8, further including a biasing element for urging said slidable grip toward said base mount.

14. The latch assembly for use with a cover for a pickup truck bed of claim 8, wherein said base mount includes a slidable grip-engaging feature and said slidable grip includes a base mount-engaging feature.

15. A latch assembly for coupling a movable component to a fixed component, the assembly comprising:
a base mount fixed to the movable component;
a cam assembly having a first cam surface and a second cam surface, said cam surfaces being adjacent and continuous with each other;
a handle assembly rotatably attached to said base mount and movable between a stowed position and a clamping position, said handle assembly comprising a lever rotatably mounted to said base mount, a slidable grip slidably mounted on said lever, and a pivotable locking arm operatively and selectively associated with said first and second cam surfaces, said pivotable locking arm including a grip for clamping against the fixed component when the handle assembly is in said clamping position.

16. The latch assembly for coupling a movable component to a fixed component of claim 8, wherein said first cam surface has a concave stowing cam profile for moving said pivotable locking arm to its stowed position.

17. The latch assembly for coupling a movable component to a fixed component of claim 8, wherein said second cam surface has a concave locking cam profile for moving said pivotable locking arm to its clamping position.

18. The latch assembly for coupling a movable component to a fixed component of claim 8, wherein said pivotable locking arm includes a follower end having a follower for engagement with said first and second cam surfaces.

19. The latch assembly for coupling a movable component to a fixed component of claim 8, further including a biasing element for urging said slidable grip toward said base mount.

20. The latch assembly for coupling a movable component to a fixed component of claim 8, wherein said base mount includes a slidable grip-engaging feature and said slidable grip includes a base mount-engaging feature.
